(19) United States
(12) Patent Application Publication
(10) Pub. No.: US 2026/0141300 A1
(43) Pub. Date: May 21, 2026

(54) Method and System for Storing Knowledge

(71) Applicant: Rouslan Biletski, Kenmore, WA (US)

(72) Inventor: Rouslan Biletski, Kenmore, WA (US)

(21) Appl. No.: 19/325,794

(22) Filed: Sep. 11, 2025

Related U.S. Application Data
(60) Provisional application No. 63/693,309, filed on Sep. 11, 2024.

(51) Int. Cl. G06N 20/00; G06N 5/02

(52) U.S. Cl. CPC G06N 20/00; G06N 5/02

(57) ABSTRACT

A method of gathering knowledge involves crawling information sources to identify objects and rules and associating objects with rules, connection data, connections, and characteristics such that objects are both stored as objects and as object descriptors, the objects relating to actual objects and the object descriptors forming a set of descriptors for objects so described.

### FIELD OF THE INVENTION

The invention relates generally to computers and more particularly to artificial intelligence.

### BACKGROUND

Large language models (LLMs) store correlations relating to vast amounts of information based on training. The abilities of large language models to interact and do human-like tasks is impressive. However, there are limitations to the functioning of large language models. One such limitation is hallucination, an identified flaw, where a large language model thinks that something is true when in fact it is not. Efforts to further train a large language model to fix hallucinations often result in other hallucinations. Thus, there is a problem where fixing a problem when found leads to new unknown problems.

A new mechanism for storing information for use in artificial intelligence is needed as current training and retraining costs are very high and predictability of AI systems is typically quite low. To date, no knowledge storage solution with competitive results to large language models has been developed for artificial intelligence.

It would be advantageous to provide a different model for information storage for use in artificial intelligence.

### SUMMARY OF EMBODIMENTS

In accordance with another embodiment there is provided a method comprising: providing an artificial intelligence processing system; for each of a plurality of objects learned by the artificial intelligence system storing object descriptions, the object descriptions comprising: an object identifier; first actions performable on and/or by the object; first characteristics of the object; and first connections of the object to other objects.

In some embodiments the first connections are physical points on a physical object represented by the object description for at least one of connecting and interfacing to other objects.

In some embodiments a first connection is a point on an outer surface of the object where a force can be applied.

In some embodiments a first connection is a point on an inner portion of the object where Newton's gravitation force is applied to the entire object.

In some embodiments a first connection is a portion of a surface on an exterior portion of the object.

In some embodiments a characteristic indicates one of rigid and malleable.

In some embodiments a characteristic indicates parameters for use in applying actions to the object.

In some embodiments an action from the first actions comprises an action and modifiers indicating application of the action.

In some embodiments some modifiers are different depending on a framework in which the action is applied.

Some embodiments comprise: ingesting knowledge from scientific documents to determine descriptions for each of a plurality of objects.

Some embodiments comprise: ingesting knowledge from experimentation and real-world sensing by the artificial intelligence system to determine descriptions for each of a plurality of objects.

Some embodiments comprise: ingesting knowledge from experimentation and real-world sensing by the artificial intelligence system to modify descriptions for each of a plurality of objects.

In some embodiments some objects inherit first characteristics from other objects or object classes.

In some embodiments some objects inherit first actions from other objects or object classes.

In some embodiments some objects inherit first descriptors from other objects or object classes.

In some embodiments the connections include a characteristic of density relating to a degree of connection.

In some embodiments the density is greater for connections that are more bound and lower for connections that are less bound such that two items attached to each other are more bound than two items in contact one with another but not directly or indirectly connected or attached.

In some embodiments the actions performed on an object are analytically verifiable and include information for use in calculating actions in at least one model or bounded solution.

In some embodiments the actions include information for application of rules of science to the object.

In some embodiments the actions include information for selecting approximations of rules of science that apply to the object.

In another embodiment there is provided a computer implemented artificial intelligence system comprising: for each object learned, storing an object identifier; first actions performable on or by the object; first characteristics of the object; and first connections of the object to other objects.

Some embodiments comprise: a processor for processing objects to determine objects with common actions and characteristics and for forming a hierarchical structure of data elements for describing the objects in a hierarchical fashion with some objects inheriting characteristics from objects higher in the hierarchy.

In accordance with another embodiment there is provided a method for storing knowledge comprising: for each of a plurality of objects storing object descriptions, the object descriptions comprising: an object identifier; actions performable on or by the object; characteristics of the object; and connections of the object to other objects.

In accordance with another embodiment there is provided a method comprising storing knowledge comprising: for each of a plurality of fields of knowledge storing rule descriptions, the rule description of a first rule comprising: at least one of qualitative and quantitative data for application of the first rule; and specific limits on application of the rule relating to at least one of application, precisions, accuracy, and input values, the specific limits setting out a boundary within which the rule is more reliable and outside of which the rule is less reliable.

In accordance with another embodiment there is provided a method comprising storing knowledge comprising: for each of a plurality of objects one of inheriting and storing applicable rules, applicable rules identified as applicable to said object for determining object behaviour.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified block diagram of information;

FIG. 2 is a simplified model of FIG. 1;

FIG. 3 is a more simplified diagram of FIG. 2;

FIG. 4 is a diagram of information simplified differently for different models;

FIG. 5 is a simplified diagram of an application of the stored information;

FIG. 6 is a simplified diagram of another application of the stored information;

FIG. 7 is a simplified diagram for ingesting the laws of mathematics; and

FIG. 8 is a simplified diagram of a sailboat.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Artificial Intelligence (AI): Artificial intelligence is a field of computer science that aims to artificially generate software that mimics all or part of human intelligence.

Training: Training is a process wherein a system is provided a stimulus and a correct output result and adjusts its correlation to produce an output result closer to the correct output result. In correlation, training allows a correlation engine to approximately match the classification of a training data set. In machine learning, training allows a system to more accurately provide an estimated result.

Training data: Training data is data used in training a computer system. Typically, training data includes Input data: Output data pairs.

Correlation engine: A correlation engine is a type of classification engine that after training correlates input data to output results. Correlation engines are typically black box processes that achieve a trained goal in an unknown way.

Black box: A black box is a process that receives input data and provides output data in a somewhat predictable manner without providing understanding of the process used to map an input data onto a resulting output data.

Large language models ingest information. Information is scanned and then correlation values derived based on the information are stored. The process is time consuming, expensive and requires frequent updates to ingest new information. Because of the nature of LLMs, each time they are trained or re-trained, new errors arise and some human managed tuning is performed to eliminate some errors.

Another way to imagine knowledge is through understanding. At first, a child might memorise their times-tables—correlate that 2 times 4 is 8, but eventually, as an engineer, the adult version of the child understands much of the underlying principles of mathematics and can explain it differently. Exponents are not simply repetitive multiplication. Logarithms are not simply look-up tables, but instead they are reverse exponentiation. Many other calculations are known—simplifications of equations that are re-derivable by the engineer. Thus, the engineer instead of memorising every problem and every solution, learns to understand the nature of problems and how to solve them.

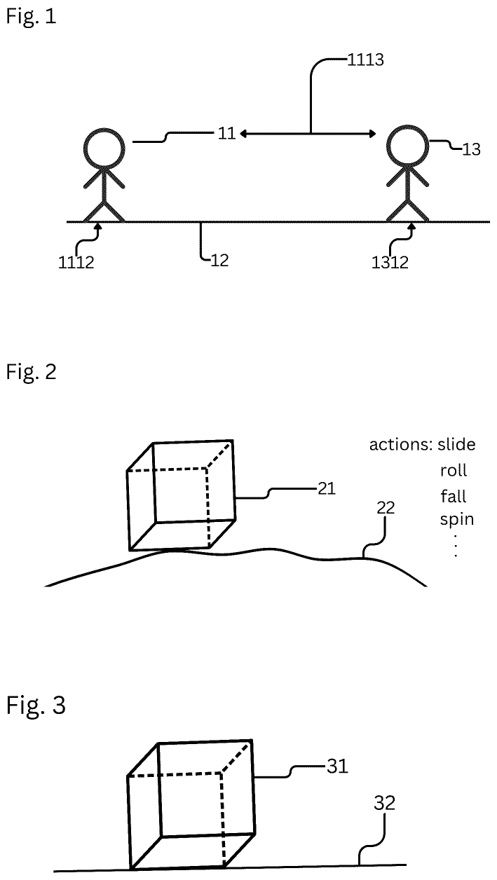

Referring to FIG. 1, shown is a simplified block diagram of information. Here, a first person 11 is standing on the ground 12. A connection between the first person 11 and the ground 12 is shown at 1112. A second person 13 is also standing on the ground 12 and has a connection to the ground 1312. The first person 11 is conversing with the second person 13 and they are communicatively coupled through the conversation at 1113. Thus, each object—the first person 11, the second person 13, and the ground 12—is shown with connections to each other object when they exist.

Referring again to FIG. 1, each object also has characteristics. Each of the first person and the second person has the following characteristics: alive, biped, mass, name, and gender. The ground has the following characteristics: planet, radius, mass, reference points, surface. Reference points exist because the planet may be simplified in some situations as a sphere that is symmetrical and when simplified with a sphere, knowing the North Pole, for example, allows all other locations to be relatively determined. Similarly, given the mass of the earth and its radius, one can determine a “force” of gravity in Newtonian dynamics and thereby characterise a connection between each person and the ground. The small number of characteristics shown, is for exemplary purposes; more characteristics is typical since the ground, being part of the earth, might be ocean or lake or mountain, etc. Further, in different paradigms, different characteristics are significant.

Referring yet again to FIG. 1, each object also has associated therewith a list of verbs—actions. Some objects reflect while others bounce. Some objects are alive and can die, while others are never alive. The list of verbs can be very long or very short depending on the object. Here, the ground is solid, but it can be dug, blasted, eroded, wet, dried, etc. Further, the ground can exert force or hold an object in place vertically. The first person can move, jump, speak, see, etc.

Each characteristic and verb potentially has some inherited aspect. Jump is a global verb for a particular behaviour, but jump for a person may be unique. Thus, a person inherits the verb Jump but may or may not assign an identical meaning to the verb. Similarly, solid and its characteristics are inherited by the ground, but the ground might be solid like granite or might be solid like sand—many solids or a grainy solid or might be solid in some situations like a non-Newtonian fluid.

Another quality associated with objects is a connection density. Connection density determines a quality or permanence of connection. Some connections are quite rigid, such as welds, while others are looser, an object standing on a table. Some connections are temporary and others more permanent. Some connections are reversible and others, such as mixing two objects or melting objects together, are not. Effectively, connection density is relied upon to determine if objects are connected, touching, acting on one another, etc. In the case of the cube on the ground, the cube is resting on the ground and held there, for example by the normal force applied to a bottom of the cube by the Earth. As the cube slides, if it slides, its contact points with the Earth change and so the connection and connection density might change.

Thus, each object is stored as a set of characteristics, verbs, connections, connection densities, and labels. Since gravity is deterministic, it need not be stored in the general knowledge store for each object, though it may be stored if it is used often enough. Similarly, verbs that are inherited need not be copied to each object. Thus inheritance allows for more efficient data storage.

Each object optionally has classifications, where classifications allow for approximation. For example, the ground is not perfectly flat, but might be approximately flat to some objects. A straight road, for example, is approximately flat for a car driving thereon. Thus classifications along with relevant explainers are also stored for objects where the set of explainers links an object to a classification and a single classification is linked to many objects. Explainers are not intended to perfectly explain how a classification is and isn't correct, instead an explainer is intended to help a system identify inappropriate generalisations based on classification. For the road mentioned above, the road may be flat for a car in dry weather but not with respect to rain or ice. Sometimes generalisations lead to ideal situations that are not applicable in real world situations.

The knowledge so stored allows for physical determinations. If the ground is water, then the first person 11 and the second person 13 either float or sink, but they do not rest on the surface. If the ground is solid, then the first person 11 and the second person 13 stand on the surface. This is calculatable and as such is a derivative of the known characteristics. If the person floats, it is by buoyancy that need not be specific to the person, but instead a general buoyancy verb should suffice. However, the air in the person's lungs affects buoyancy and, as such, either the buoyancy is calculated and re-calculated as the individual breaths, or the inherited buoyancy is modified to account for breathing.

Referring to FIG. 2, the simplified model of FIG. 1 is extrapolated. Here, a cube 21 is resting on the ground 12. The cube 21 is solid and has a solid outer surface formed of six (6) square flat sides. The outer surface of the cube 21 in its entirety is defined as a possible physical connection point, though very little of the surface is in contact with the ground. The cube has verbs like roll, slide, move, rest, contact, etc. The ground 12 is also characterised as a potential contact point. Each place where the ground contacts the bottom surface of the cube is a contact point. This is determinable and therefore need not be stored. In some simplifications, the ground will be seen as a flat surface contacting the flat outer surface of the cube; this will simplify calculations.

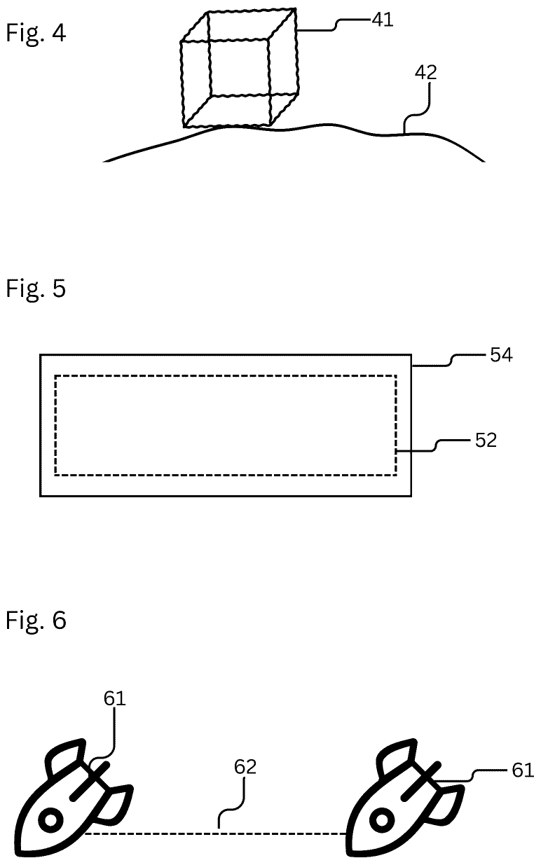

Referring to FIG. 3, shown is a simplified diagram of FIG. 2. Here, the ground 32 is simplified as a flat surface fully in contact with the bottom of the cube 31. Still, once we know that the two surfaces are in contact, we can determine that the cube rests on the surface in FIG. 3 or slides on the surface in FIG. 4 because the surface is sufficiently inclined, or falls off the surface in FIG. 5 when the surface is inclined too greatly to support the cube 31.

If the cube is a perfect cube, rotating it so that a different surface faces the ground has an identical result.

Thus, knowledge is stored in relation to fundamental mathematics, physics, operators, verbs, and characteristics and is then usable to deduce realities. Advantageously, take this same cube and place it on the surface of the moon and different results occur, but the system accommodates this since the moon has a different mass, so gravity is different; the moon also has a different surface topology and so forth. Further beneficially, given a large number of objects on the Earth, some will share certain characteristics allowing them to be generalised. For example, all objects would experience a similar gravity. Once that characteristic is identified, it can be generalised and labeled.

Referring to FIG. 4, shown is a simplified diagram of same information simplified differently. Here, a cube rests on the ground. In the first block 41, the cube is formed of 99.9% pure copper with an atomic distribution that is known. The sides of the cube are flat to within 1 micrometer. The sides of the cube are identical to within 1 micrometer. The surface topologies and dimensions are known precisely. The ground topology across the entire ground is known precisely as is the precise mass of the Earth, radius of the Earth, and altitude of the ground.

Using the information in block 41 shown with exaggerated errors in scale, it is possible to analyse the interface—the connection-between the ground and the face of the cube, precisely.

In block 42, the cube is simplified to being pure copper evenly distributed across its structure and a perfect cube. This is not completely accurate, but for the vast number of applications, the simplification is irrelevant, and as such, the simplification is useful for simplifying calculations where the simplification does not substantially change the results. For example, if the ground were a smooth surface at an incline and the issue is to resolve whether the cube would “slide,” there are many inclines where the cube slides with or without the simplification. There are others where the cube remains at rest with or without the simplifications. However, at the boundary where the simplifications could affect a predicted result, then the simplified block is less suitable.

Thus, the generalisation need only provide information for guessing the boundary region to allow for simpler and potentially generalised mathematical calculations to suffice.

Further simplified block 43 has a perfect cube of pure copper and a homogenous ground surface that follows a mathematical formula—for example a flat surface or a parabolic surface. A mathematical description of the surface allows for simple calculation of slope, for example, that affects whether the cube slides or does not slide.

Blocks 44 and 45 include further simplified forms of the information.

Of note, blocks 42, 43, 44, and 45 are automatically derivable from block 41 and more particularly derivable for particular applications or for an application within certain regions of operation.

Referring to FIG. 5, shown is one such application. Here, a steel plate is being designed to support an automobile. The process that designs the steel plate adds 25% to any determined requirement 52, as a safety margin 54. Thus, knowing the width of the car is important but only to within a known tolerance. Similarly, knowing the weight of the car is important but only to within a tolerance. Thus, if a car has a width when assembled of between 2 meters and 2.1 meters, simplifying the car width to either 2 meters or 2.1 meters results in a steel plate of sufficient dimension, 1.25* either 2 or 2.1 meters. Thus, simplifying the car width is straightforward. Similarly, for most other characteristics. The weight distribution of the car on the tires can be simplified as having even distribution. The tire inflation can be assumed to be perfect, etc. Even if the simplifications are incorrect for the actual car placed on the steel plate, the 25% “safety” margin renders the simplifications of little concern. Similarly, the steel plate is assumed to be homogenous and the pull of gravity can be approximated without knowing the exact altitude. The strength of the steel plate can be simplified instead of needing to know the exact temperature and physical composition of the steel plate.

Referring to FIG. 6, shown is another example wherein two spaceships 61 traveling near the speed of light are communicating with a laser optical signal 62. Here, very precise alignment requires relativistic mathematics and positioning of the lasers relies on a gimbal and its specific hardness or springiness, etc. Thus, simplification of many characteristics is not possible if the lasers are going to line up correctly.

When the spaceships slow down to Newtonian speeds, a simplification becomes usable. Thus, in some situations a simplified model is exported for use and in others the information is used as captured. In yet another embodiment, the system switches between models or selects the model based on the situation.

When the two spaceships are at rest one relative to the other, an even more simple solution exists. Thus, for a single problem with the same two objects, three solutions exist and are each applicable to different ranges of movement. The relativistic solution always works, but is processor intensive; the stationary solution only works when the ships are stationary one relative to the other but is very processing efficient.

Highly advantageously, there are tables outlining or specifying the strength of steel. Though the tables are formed using steel of a particular composition and structure, the tables suffice in many real-world applications. Similarly, gravity at the surface of the Earth and 20M above the surface of the Earth can be approximated as 9.8M/s² for most applications.

Thus, once amassed, the knowledge so stored forms a basis for a system 2 type-Analytical thought-learning and retrieval. Storing information and using knowledge to extrapolate is not only useful for simplification. It is also useful to identify boundaries where the simplifications fail. For example a temperature at which the steel plate no longer will reliably support a car, even with the 25% “safety” margin.

The knowledge so stored serves other purposes. It is useful for verifying previous results to identify, for example, hallucinations. When hallucinations are identified, instead of retraining, the system can simply prevent the hallucinated response—filter the single response. Optionally, the analytical system can provide the correct response.

Another result of storing information as described hereinabove is that information can be extracted from the structure of the stored information. For example, a gear box changes an input torque into an output torque through a mathematical transform. This type of transformation, from the perspective of some element of the gear box is “amplification.” Similarly, an audio amplifier changes an input voltage to a different output voltage, where voltage is the element that is subject to “amplification.” Thus, storing information as verbs, characteristics and connections allows for analogy. A gear box is a mechanical system/part analogous to an electronic amplifier for an electronic system. This allows a system to suggest improvement or modification by analogy, something at the heart of creativity. This also allows a system to simplify elements into black boxes and therefore rely on any suitable black box for a given purpose—a steel beam, a wood beam, a cable, etc. It also allows analogous comparisons. Finally, it allows direct comparisons, either based on the actual information or based on a simplification of the information. An irregular sphere rolls sometimes and slides others; when it is sliding over a long distance, it is like a cube or other flat sided object. similarly, the tires on a car act as a cylinder when rolling (though they are flat on the bottom) and as a non-cylinder when the brakes lock the wheels in place and the wheels do not rotate. This need not be known if the car parts, their verbs and their interconnections are known as is the road and its connections; then the effect of wheels rolling vs. locked is determinable.

Labels, for example verbs, are also beneficial because in different languages different words are associated differently. In one language, a gear box amplifies torque and an electronic amplifier amplifies voltage. In another language other correlations are highlighted through verbs. Creativity, again, is a function of disparate links and different languages provide views of these differences.

By associating items with black boxes, hierarchical structures are formable and simplifiable. A gear box need not be specified as its parts, it is a gear box—black box for amplifying torque. The insides are specifiable as well and then are also interchangeable with other gear boxes. For example, a user specifies a gear box for a design by its minimum ratings. The system is designed with the custom gearbox and it is defined in nature having a size, shape, verbs, characteristics, etc. That said, before entering production, the designer can search for gear boxes that meet the minimum specification and that are already available, for example to save time or money. Thus, the black box allows replacement, changes, approximation, or simply viewing the gear box as a black box instead as an assembly of parts. The black box turns the gear box into a hierarchical model—gear box (black box)>gear box design (diagram)>gear box composition (parts).

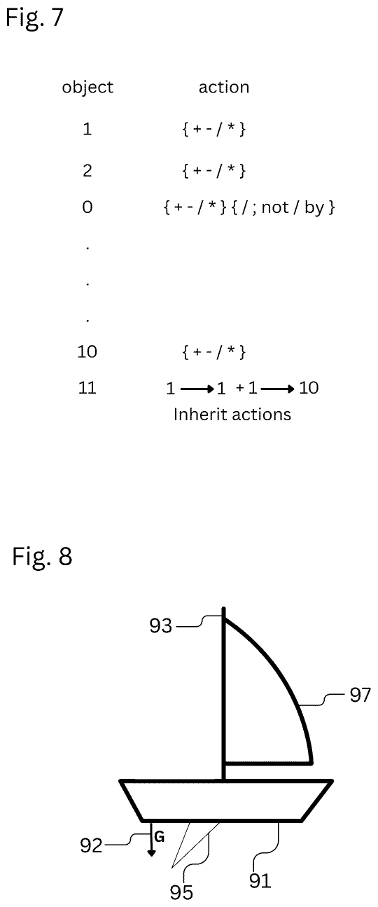

Referring to FIG. 7, shown is a simplified diagram of applying the information ingestion system to mathematics. In mathematics, there are no physical connections because numbers are theoretical in pure mathematics. That said, one cannot divide by the number 0, for example, so some numbers and formula have verbs or limitations. Also, the number 4 is connected to the number 2 by multiplying it by 2, so numbers are connected by equations or operators.

If a system is provided basic math skills—addition and multiplication—and definitions of symbols, it can break math down into a series of operations. Addition can be stored as billions of pairings and their results—a lookup table-or as a process—an operation. By relying on operations when possible, all of mathematics is simplified such that long equations are a mere function of many simple operations. Exponentiation is simply repeated multiplication, for example. When used often, a function is stored in an efficient solution, when known. When not used often, the function is stored however it is. As the system parses more and more mathematics texts, it learns more and more mathematics and stores the math as fundamental knowledge. The knowledge is again stored with simplifications when that is suitable, such that the real math can be used or a simplified version is usable when it is an advantage. For money, multiplication is limited to two or three decimal places. For temperature in a household one decimal place suffices, etc. That said, the multiplication of real numbers is known and repeatably performable by the system.

Advantageously, the system both learns math and stores math in a fashion that it can explain to people and therefore the fundamental knowledge is collected and stored in a verifiable fashion because the system can “explain” it. If you ask the system how it performs exponentiation, it could retrieve its process and other processes that will work such as repeated multiplication.

Unlike a large language model, the knowledge store is not a black box, but instead a series of objects, definitions, operators (verbs), and labels—for communication with people or other systems—and characteristics. If the mass of the Earth is expressed in Stone, then the system knows the mass of one Stone and can instead present the mass in pounds or grams or another measure given that another measure is known. I could ask for the mass of the Earth in units of the mass of my dog at 9 AM today as long as the system knows the mass of my dog at 9 AM today. This is deterministic in nature. That said, I might ask the question for comparison and be seeking an approximate number such that the system can take the average mass of my dog, the average mass of a dog of the same breed, etc. Simplification is supported both because the end result can be verified using real values and because the system has already determined where the simplifications are insufficient for a purpose.

Returning to FIG. 1, first person 11 and second person 13 are communicatively coupled. As such, when the system is provided information relating to communication between people, the system determines effects of said coupling and potentially measures actual effects to determine differences between determined effects and actual effects. Alternatively, some communications, for example between computer systems, have deterministic effects. If first person 11 and second person 13 are speaking, then dissipation of sound is relevant as is the medium through which the sound travels. If they are using WiFi, there are other considerations.

Referring to FIG. 8, shown is a sailboat. The sailboat has a hull 91 for connecting to something below the boat by gravity 92. The boat has a mass, volume, and hull surface for use in calculating its buoyancy. The boat has a mast 93 connected to the boat and a keel 95 extending below the boat for stability. A sail 97 is connected to the mast and has a connection to air and water. Sails can be “blown” or propelled by air or water. Knowing the wind direction, the sail geometry and position, etc. allows a simplified calculation of the sailboat's acceleration/speed. Thus, a model of airflow and fabric positioning is supported for daily use. A sailboat designer, however, would want to learn more about sail performance with wind currents and eddies, fabric fluttering, etc. The sailboat designer would want to learn about the listing of the sailboat as the wind hits it, the flexion in the mast, etc. For a hobby sailor, assuming the mast is straight and rigid is often sufficient; for the designer, not so.

Thus, once the information about the sailboat is injested, the system is capable of helping in the design/re-design process using complex engineering analysis involving few approximations. The same information is useful in simulating the sailboat for test and verification. A simplification involving many approximations is helpful to the hobby sailor for providing information and assisting in sailing. Both models are useful for animation of the sailboat for different purposes. Either model or a further simplified model is useful for teaching about the sailboat and its operation.

The storage of knowledge as objects, real or virtual, connections and verbs (operators) allows for building hierarchical models that approximate real objects and simplify analysis. This allows for different understanding for different applications.

Numerous other embodiments can be envisaged without departing from the spirit or scope of the invention.

What is claimed is:

1. A method for storing knowledge comprising:
providing an artificial intelligence processing system;
for each of a plurality of objects learned by the artificial intelligence system storing object descriptions, the object descriptions comprising:
an object identifier;
first actions performable on and/or by the object;
first characteristics of the object; and
first connections of the object to other objects.

2. A method according to claim 1 wherein the first connections are physical points on a physical object represented by the object description for at least one of connecting and interfacing to other objects.

3. A method according to claim 2 wherein a first connection is a point on an outer surface of the object where a force can be applied.

4. A method according to claim 2 wherein a first connection is a point on an inner portion of the object where Newton's gravitation force is applied to the entire object.

5. A method according to claim 2 wherein a first connection is a portion of a surface on an exterior portion of the object.

6. A method according to claim 2 wherein a characteristic indicates one of rigid and malleable.

7. A method according to claim 2 wherein a characteristic indicates parameters for use in applying actions to the object.

8. A method according to claim 7 where an action from the first actions comprises an action and modifiers indicating application of the action.

9. A method according to claim 8 wherein some modifiers are different depending on a framework in which the action is applied.

10. A method according to claim 1 comprising: ingesting knowledge from scientific documents to determine descriptions for each of a plurality of objects.

11. A method according to claim 1 comprising: ingesting knowledge from experimentation and real-world sensing by the artificial intelligence system to determine descriptions for each of a plurality of objects.

12. A method according to claim 1 comprising: ingesting knowledge from experimentation and real-world sensing by the artificial intelligence system to modify descriptions for each of a plurality of objects.

13. A method according to claim 12 wherein some objects inherit first characteristics from other objects or object classes.

14. A method according to claim 12 wherein some objects inherit first actions from other objects or object classes.

15. A method according to claim 12 wherein some objects inherit first descriptors from other objects or object classes.

16. A method according to claim 1 wherein the connections include a characteristic of density relating to a degree of connection.

17. A method according to claim 16 wherein the density is greater for connections that are more bound and lower for connections that are less bound such that two items attached to each other are more bound than two items in contact one with another but not directly or indirectly connected or attached.

18. A method according to claim 1 wherein the actions performed on an object are analytically verifiable and include information for use in calculating actions in at least one model or bounded solution.

19. A method according to claim 18 wherein the actions include information for application of rules of science to the object.

20. A method according to claim 19, wherein the actions include information for selecting approximations of rules of science that apply to the object.

21. An artificial intelligence system comprising:
for each object learned, storing
an object identifier;
first actions performable on or by the object;
first characteristics of the object; and
first connections of the object to other objects.

22. The artificial intelligence system of claim 21 comprising:
a processor for processing objects to determine objects with common actions and characteristics and for forming a hierarchical structure of data elements for describing the objects in a hierarchical fashion with some objects inheriting characteristics from objects higher in the hierarchy.
